(19) United States
(12) Patent Application Publication
(10) Pub. No.: US 2008/0151877 A1
(43) Pub. Date: Jun. 26, 2008

(54) Method of updating internet protocol phone contact information in general phone

(75) Inventors: Cheng-Shing Lai, Taipei (TW); Bin Chang, Nanking (CN)

Correspondence Address: BACON & THOMAS, PLLC, 625 SLATERS LANE, FOURTH FLOOR, ALEXANDRIA, VA, 22314, US

(73) Assignee: Inventec Applicances Corp., Taipei (TW)

(21) Appl. No.: 11/878,655

(22) Filed: Jul. 26, 2007

(30) Foreign Application Priority Data
Dec. 25, 2006 (TW) 095148720

(51) Int. Cl. H04L 12/56

(52) U.S. Cl. 370/353

(57) ABSTRACT

The present invention is to provide a method of updating Internet protocol phone contact information in general phone which establishes a connection between an Internet protocol phone and a general phone, wherein a first contact information is stored in the Internet protocol phone while a second contact information is stored in the general phone. When it is determined that the first contact information is updated, the Internet protocol phone copies the first contact information to a third contact information, packs the third contact information to generate a changed data packet, and sends the changed data packet to the general phone. After the changed data packet is received by the general phone, the general phone stores the third contact information to replace the second contact information.

### FIELD OF THE INVENTION

The present invention relates to a method of updating Internet protocol phone contact information in a general phone, more particularly to a method of updating the contact information stored in the general phone by using the corresponding contact information stored in the Internet protocol phone when it is determined that the corresponding contact information stored in the Internet protocol phone is changed.

### BACKGROUND OF THE INVENTION

Currently the major telephone systems operate over the public switched telephone networks (hereinafter abbreviated as PSTN) and the switch of circuits thereof is mainly performed by the offices or companies of telecommunication. When a phone gets through, the line between a caller and a receiver may be regarded as a reserved line charged by distance which will be quite expensive when the call is made between countries. Besides, for data like voice, video or the like to be processed, companies are required to deploy individual networks with different requirements for transmission which will be costly concerning establishment, maintenance and re-configuration thereof. Even the software and hardware structures of said networks are completely different from each other which makes it very difficult for them to be integrated and thus limit their potential uses.

Recently, broadband networks have been constructed worldwide after the emergence of the Internet. The new technology that processes data like voice, video or the like with all kinds of Internet Protocol (IP) and transmits said data on the Internet in packets not only overcomes the shortcomings stated above but also reduces the transmission cost substantially.

Regarding the technology of transmitting voice over the network, it is composed of Internet protocol phone, voice over Internet protocol (VoIP for short) and certain network devices (such as a VoIP Gateway). The voices received by the caller's Internet protocol phone will be digitalized and compressed by the VoIP and transmitted to the receiver in packets via the Internet, while the receiver may restore the voice by using the VoIP in a counter way and hear the caller through the Internet protocol phone and network devices. Thus, the conversation between users may be carried out without making a long distance call via the conventional PSTN and therefore a considerable sum of telephone fee may be saved.

Furthermore, users of the Internet protocol phone and general phone nowadays may communicate with each other through the Internet and the PSTN which substantially expands the scope of telecommunication and makes it more and more popular for users of network services or those with needs for transnational communication.

However, when making a phone call under said scheme, the user of the general phone is required to enter the whole user name for the call to get through which is time-consuming and inconvenient. Besides, though the user of the general phone can make a speed dial by using the user names stored in the telephone directory thereof, the change of the user name of the Internet protocol phone user may result in failure of making the call by the general phone user. Furthermore, the general phone today is not equipped with the function of updating and synchronizing the contact information of the general phone user according to the contact information of the Internet protocol phone user, so the user of the general phone is required to manually enter the user name to make a phone call or update the contact information one by one. Hence, to get rid of the disturbing problems faced by the user of the general phone during actual use has become an important issue to be solved.

### SUMMARY OF THE INVENTION

For the purpose of solving the above problems that users of the general phone may encounter during actual use, after hard work of research and experiments for a long time, the inventor has developed a method of updating Internet protocol phone contact information in general phone.

According to one aspect of the present invention is to provide a method of updating corresponding contact information in Internet protocol phone and general phone after establishes a connection between an Internet protocol phone and a general phone, wherein a first contact information is stored in the Internet protocol phone while a second contact information is stored in the general phone. When it is determined that the first contact information is updated, the Internet protocol phone copies the first contact information to a third contact information, packs the third contact information to generate a changed data packet, and sends the changed data packet to the general phone. After the changed data packet is received by the general phone, the general phone stores the third contact information to replace the second contact information. Thus, the objective of updating Internet protocol phone contact information in general phone may be achieved and the problems stated above may be solved.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 shows a general phone and an Internet protocol phone of an embodiment of the present invention; and

FIG. 2 is a flow chart of updating contact information of an embodiment of the present invention.

### DETAILED DESCRIPTION OF THE PREFERRED EMBODIMENT

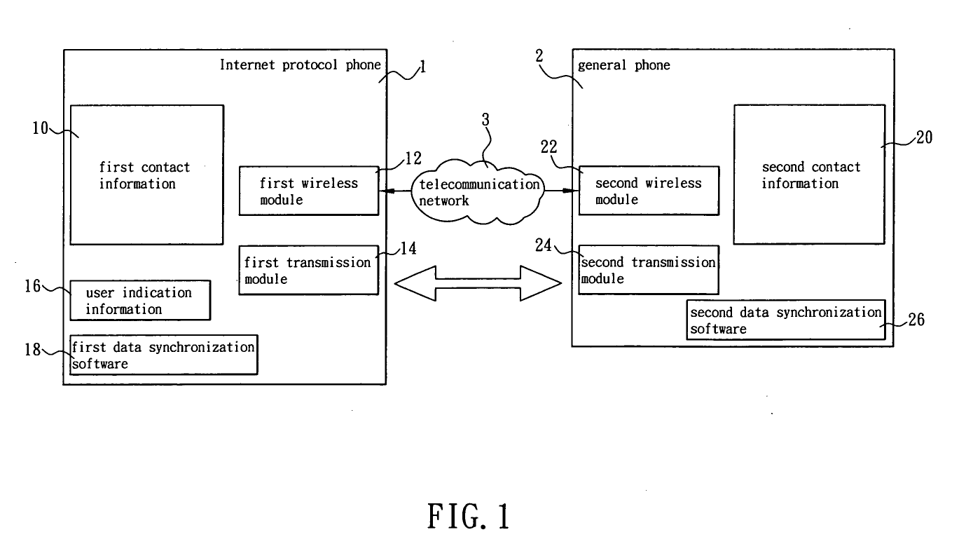

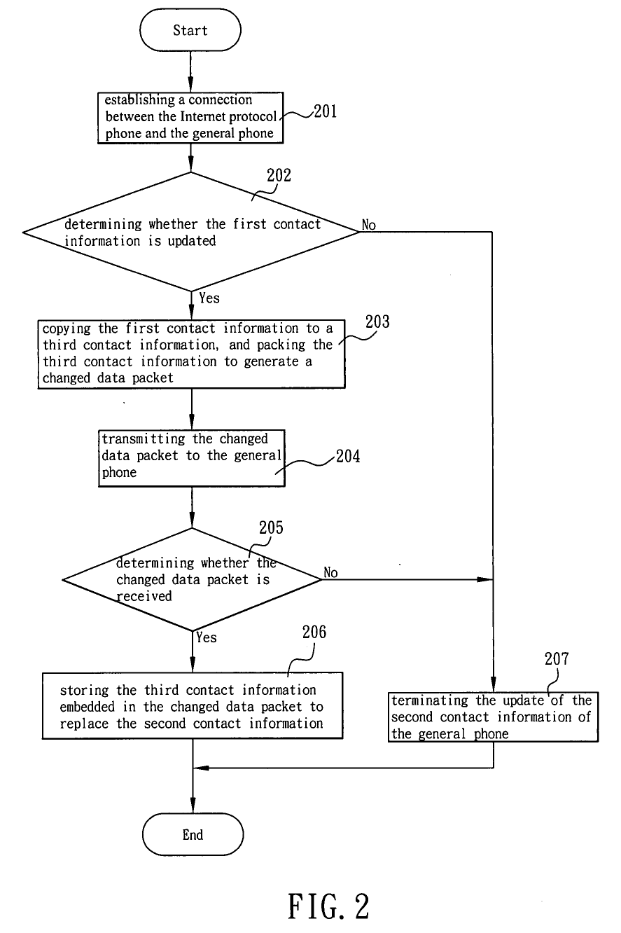

Please refer to FIG. 1, one embodiment of the present invention that relates to a method of updating Internet protocol phone contact information in general phone is applied between an Internet protocol phone 1 and a general phone 2, wherein the Internet protocol phone 1 is an end-to-end real time communication device which digitizes voice signals originally in an analog format, and makes real time transmission of voice signals in “data packets” through related protocols via the IP network. The general phone 2 is referred to the local telephone utilizing the public switched telephone network (PSTN for short) 3 for communication or the mobile phone utilizing the mobile communication system like the global system of mobile communication (GSM), general packet radio service (GPRS), code division multiple access (CDMA) or the like. And a first contact information 10 is stored in the Internet protocol phone 1, while a second contact information 20 is stored in the general phone 2. Please refer to FIG. 2, the method of one embodiment of the present invention comprises the steps of:
(201) establishing a connection between the Internet protocol phone 1 and the general phone 2;
(202) the Internet protocol phone 1 determining whether the first contact information 10 (such as a telephone directory or user name etc.) is updated, proceeding with the step (203) when affirmative, otherwise going to the step (207);
(203) the Internet protocol phone 1 copying the first contact information 10 to a third contact information, and packing the third contact information to generate a changed data packet;
(204) the Internet protocol phone 1 transmitting the changed data packet to the general phone 2;
(205) the general phone 2 determining whether the changed data packet is received, proceeding with the step (206) when affirmative, otherwise going to the step (207);
(206) the general phone 2 storing the third contact information embedded in the changed data packet to replace the second contact information 20; and
(207) terminating the update of the second contact information 20 of the general phone 2.

Thus, each time a change is made to the first contact information 10 stored in the Internet protocol phone 1, the corresponding second contact information 20 stored in the general phone 2 is updated, thereby overcomes the shortcomings that the user is required to enter user name to make a phone call and update user names and contact information one by one.

Please refer to FIG. 1, in one embodiment of the present invention, the Internet protocol phone 1 is equipped with a first wireless module 12, and the general phone 2 is equipped with a second wireless module 22. In order to establish a connection between the Internet protocol phone 1 and the general phone 2, the first wireless module 12 of the Internet protocol phone 1 and the second wireless module 22 of the general phone 2 connect with a telecommunication network 3 (such as GSM, CDMA, PHS etc.) respectively, and the Internet protocol phone 1 establishes a connection with the general phone 2 via the telecommunication network 3 to proceed transmission of the changed data packet.

Please refer to FIG. 1, in said embodiment, when establishing a connection with the general phone 2 via the telecommunication network 3, the Internet protocol phone 1 first retrieves a user indication information 16 stored therein, and then establishes a connection with the general phone 2 indicated by the user indication information 16. Thus, the update of the contact information of the general phone 2 indicated by the user indication information 16 may proceed.

Please refer to FIG. 1, in another embodiment of the present invention, when establishing a connection with the general phone 2, the Internet protocol phone 1 generates a first connection signal and transmits said first connection signal to the general phone 2 through its first transmission module 14. When the first connection signal is received by a second transmission module 24 of the general phone 2, the general phone 2 generates a second connection signal and transmits said second connection signal to the Internet protocol phone 1 through the second transmission module 24. While the second connection signal is received by the first transmission module 14 of the Internet protocol phone 1, the connection between the Internet protocol phone 1 and the general phone 2 is established for the transmission of the changed data packet to proceed.

Please refer to FIG. 1, in said another embodiment, the first transmission module 14 and the second transmission module 24 carry out short range transmission of the first connection signal, the second connection signal and the changed data packet directly according to the bluetooth or infrared protocol so that the second contact information 20 of the general phone 2 may be updated in a more efficient manner. Besides, the first transmission module 14 and the second transmission module 24 may be universal serial bus (USB) ports that after connected with a transmission wire, the first transmission module 14 and the second transmission module 24 may carry out short range transmission of the first connection signal, the second connection signal and the changed data packet directly.

Please refer to FIG. 1, in said embodiments, a first data synchronization software is installed in the Internet protocol phone 1. When changing the first contact information 10 to the third contact information, the Internet protocol phone 1 retrieves the third contact information by using the first data synchronization software 18, and packs the third contact information according to the format of electronic business card (i.e. “VCARD”, a format for document transmission) to generate the changed data packet. Besides, a second data synchronization software 26 is installed in the general phone 2. After the changed data packet is received, the general phone 2 reads the changed data packet by using the second data synchronization software 26, and stores the third contact information according to the format of electronic business card to replace the second contact information 20.

Furthermore, by taking advantage of the characteristics of VCARD, the method of updating Internet protocol phone contact information in general phone of the present invention may be applied between all kinds of devices or systems as well as update the Internet protocol phone 1 contact information in the general phone 2 directly by email etc.

As stated above, with the method of updating Internet protocol phone contact information in general phone according to the embodiments of the present invention, the following objectives may be achieved:

1. The user of the general phone 2 can make a speed dial or establish a connection easily by using the contact information stored therein;

2. The contact information stored in the general phone 2 and that of the Internet protocol phone 1 may be synchronized through mobile communication system (such as GSM, CDMA, PHS etc.), thus there is no need for the user to enter data one by one or to update the contact information repeatedly;

3. The contact information in the general phone 2 may be updated in a more efficient way through short range transmission; and

4. The method of the present invention may be applied between all kinds of devices or systems by utilizing the data synchronization software 18, 26 and the format of electronic business card or directly by email etc. which makes it more convenient to update the contact information.

While the invention herein disclosed has been described by means of specific embodiments, numerous modifications and variations could be made thereto by those skilled in the art without departing from the scope and spirit of the invention set forth in the claims.

What is claimed is:

1. A method of updating Internet protocol phone contact information in general phone applied between an Internet protocol phone and a general phone, comprising:
establishing a connection between said Internet protocol phone and said general phone, wherein a first contact information is stored in said Internet protocol phone while a second contact information is stored in said general phone;
copying said first contact information of said Internet protocol phone to a third contact information of said Internet protocol phone when it is determined that said first contact information is updated;
packing said third contact information of said Internet protocol phone to generate a changed data packet;
transmitting said changed data packet of said Internet protocol phone to said general phone; and
receiving said changed data packet of said general phone, and stores said third contact information embedded therein to replace said second contact information.

2. A method of updating Internet protocol phone contact information in general phone of claim 1, wherein the step of establishing a connection between said Internet protocol phone and said general phone comprising:
establishing a connection between a first wireless module of said Internet protocol phone with a telecommunication network;
establishing a connection between a second wireless module of said general phone with said telecommunication network; and
establishing a connection between said Internet protocol phone with said general phone via said telecommunication network.

3. A method of updating Internet protocol phone contact information in general phone of claim 2, wherein the step of said Internet protocol phone establishing the connection with said general phone via said telecommunication network comprising:
retrieving a user indication information stored in said Internet protocol phone; and
establishing a connection between said Internet protocol phone and the indicated general phone according to said user indication information.

4. A method of updating Internet protocol phone contact information in general phone of claim 2, wherein the step of said Internet protocol phone packing said third contact information to generate said changed data packet further comprising:
retrieving said third contact information of said Internet protocol phone by using a first data synchronization software installed in said Internet protocol phone; and
packing said third contact information according to a format of electronic business card to generate said changed data packet.

5. A method of updating Internet protocol phone contact information in general phone of claim 1, wherein the step of establishing the connection between said Internet protocol phone and said general phone comprising:
generating a first connection signal of said Internet protocol phone;
transmitting said first connection signal to said general phone through a first transmission module of said Internet protocol phone;
receiving said first connection signal by a second transmission module of said general phone, and transmits a second connection signal to said Internet protocol phone through said second transmission module; and
establishing a connection between said Internet protocol phone and said general phone after said first transmission module of said Internet protocol phone receives said second connection signal.

6. A method of updating Internet protocol phone contact information in general phone of claim 5, wherein the step of said Internet protocol phone packing said third contact information to generate said changed data packet further comprising:
retrieving said third contact information of said Internet protocol phone by using a first data synchronization software installed in said Internet protocol phone; and
packing said third contact information according to a format of electronic business card to generate said changed data packet.

7. A method of updating Internet protocol phone contact information in general phone of claim 6, wherein the step of said general phone receiving said changed data packet and storing said third contact information embedded therein to replace said second contact information further comprising:
reading said changed data packet by using a second data synchronization software installed in said general phone; and
storing said third contact information embedded in said changed data packet according to the format of electronic business card to replace said second contact information.

8. A method of updating Internet protocol phone contact information in general phone of claim 7, wherein said general phone is a mobile phone.

9. A method of updating Internet protocol phone contact information in general phone of claim 7, wherein said general phone is a local telephone.

10. A method of updating Internet protocol phone contact information in general phone of claim 7, wherein said first transmission module and said second transmission module transmit said first connection signal, said second connection signal and said changed data packet by using bluetooth protocol.

11. A method of updating Internet protocol phone contact information in general phone of claim 7, wherein said first transmission module and said second transmission module transmit said first connection signal, said second connection signal and said changed data packet by using infrared protocol.

12. A method of updating Internet protocol phone contact information in general phone of claim 5, wherein said Internet protocol phone packing said third contact information to generate said changed data packet further comprising:
reading said third contact information by using a first data synchronization software installed in said Internet protocol phone; and
packing said third contact information according to a format of electronic business card to generate said changed data packet.

13. A method of updating Internet protocol phone contact information in general phone of claim 12, wherein the step of said general phone receiving said changed data packet and storing said third contact information embedded therein to replace said second contact information further comprising:
reading said changed data packet by using a second data synchronization software installed in said general phone; and
storing said third contact information embedded in said changed data packet according to the format of electronic business card to replace said second contact information.

14. A method of updating Internet protocol phone contact information in general phone of claim 13, wherein said general phone is a mobile phone.

15. A method of updating Internet protocol phone contact information in general phone of claim 13, wherein said general phone is a local telephone.

16. A method of updating Internet protocol phone contact information in general phone of claim 13, wherein said first transmission module and said second transmission module transmit said first connection signal, said second connection signal and said changed data packet by using bluetooth protocol.

17. A method of updating Internet protocol phone contact information in general phone of claim 13, wherein said first transmission module and said second transmission module transmit said first connection signal, said second connection signal and said changed data packet by using infrared protocol.
